(19) United States
(12) Patent Application Publication
(10) Pub. No.: US 2017/0248363 A1
(43) Pub. Date: Aug. 31, 2017

(54) DOMESTIC APPLIANCE WITH A LAMP FOR ILLUMINATING A RECESSED HANDLE OF A DOOR

(71) Applicant: BSH HAUSGERAETE GMBH, MUENCHEN (DE)

(72) Inventors: MAX EICHER, MUENCHEN (DE); CHRISTOPH BECKE, GROSSKAROLINENFELD (DE); CHRISTINE HARTWEIN, NANDLSTADT (DE); TANJA DENNINGER, MUENCHEN (DE)

(21) Appl. No.: 15/444,407

(22) Filed: Feb. 28, 2017

(30) Foreign Application Priority Data
Feb. 29, 2016 (DE) 10 2016 203 180.5

(51) Int. Cl. F25D 27/00; F21V 23/04; F21V 33/00; F25D 23/02; F21V 8/00

(52) U.S. Cl. CPC F25D 27/005; F25D 23/028; G02B 6/0023; G02B 6/0035; F21V 33/0044; F21V 23/0471; F25D 2700/04; F21W 2131/305

(57) ABSTRACT

A domestic appliance, in particular a domestic refrigeration appliance, has a lamp for illuminating a recessed handle of a door. The recessed handle has a recess. The door has a light-guide element in the recess and the door also has a light source for illumination into the light-guide body at least on a front end of the light-guide body.

### CROSS-REFERENCE TO RELATED APPLICATION

This application claims the priority, under 35 U.S.C. §119, of German application DE 10 2016 203 180.5, filed Feb. 29, 2016; the prior application is herewith incorporated by reference in its entirety.

### BACKGROUND OF THE INVENTION

Field of the Invention

The present invention relates to a domestic appliance, in particular a domestic refrigeration appliance, with a lamp for illuminating a recessed hand.

Doors with a recessed handle integrated into the door leaf are widely used in domestic appliances, in particular in domestic refrigeration appliances. In order to assist a user with orientation especially with minimal ambient light, it has been proposed to illuminate the recessed handle.

Chinese patent CN 202813969 discloses a domestic refrigeration appliance having a door with an illuminated recessed handle on an end face of the door. An illuminated surface with LEDs extends across the length of an indentation in the recessed handle and is glued into the indentation of the recessed handle. A strip of silicon rubber for scattering the light is disposed in front of the illuminated surface with LEDS when viewed from the open recessed handle. The strip of silicon rubber is disposed in a holder, which interlocks with walls of the indentation of the recessed handle.

### SUMMARY OF THE INVENTION

The object of the present invention is to create a domestic appliance, in particular a domestic refrigeration appliance, with a lamp, which is cost-effective and can be easily assembled, for illuminating a recessed handle of a door of the domestic appliance.

The object is achieved by the subject matter with the features of the main claim. Advantageous embodiments of the invention form the subject matter of the figures, the description and the dependent claims. Different embodiments can in most cases be suitably combined with one another.

A domestic appliance, in particular a domestic refrigeration appliance, has a door with a recessed handle and a lamp for illuminating the recessed handle. The recessed handle has a recess, in which a light-guide body is arranged, wherein a light source for illumination into the light-guide body is arranged at least on one front end of the light-guide body. The light-guide body in the recess and the lamp on an end face of the light-guide body produce an illumination of a recessed handle, which is cost-effective and easy to assemble, in the door of the domestic appliance.

In a simple version, only two components are required and a power supply is required on just one upper and/or lower side of the door.

In an advantageous embodiment of the domestic appliance, the light source has an LED. This means that the technical advantage is achieved for instance that the light source is of a compact design and is highly efficient.

According to an advantageous embodiment, the lamp has optics for coupling light from the light source into the light-guide body. This means that the technical advantage is achieved for instance that the light source and the light-guide body can be attuned to one another in respect of a light beam path. Thus on the one hand the degree of efficiency of the light transmission can be improved and on the other hand a light distribution within the light-guide body can be influenced. If the light source has an LED, the optics can be integrated into the LED.

In an advantageous embodiment of the domestic appliance, the light-guide body has a surface with a light out-coupling structure. This means that the technical advantage is achieved for instance that a desired distribution of the brightness of the out-coupled light can be produced across a length of the light-guide body.

According to an advantageous embodiment of the domestic appliance, the light out-coupling elements are arranged on a front side of the light-guide body facing an open side of the recessed handle or on an opposing rear side of the light-guide body. This means that the technical advantage is achieved for instance that convenient out-coupling of the light into the recessed handle can be obtained in a variety of ways.

In an advantageous embodiment of the domestic appliance, light out-coupling elements are unevenly distributed across the length of the light-guide body. This means that the technical advantage is achieved for instance that a brightness distribution of the light out-coupling from the light-guide body can be selected across the length of the light-guide body.

In an advantageous embodiment of the domestic appliance, the light-guide body is glued into the recess of the recessed handle. This means that the technical advantage is achieved for instance that the light-guide body can be positioned and fixed in an easily controllable manufacturing step.

In an advantageous embodiment of the domestic appliance, the light-guide body is glued onto a rear side or onto at least one lateral surface in the recess of the recessed handle. This means that the technical advantage is achieved for instance that different surfaces can be selected for the adhesion. One advantage also lies in the possibility of providing an out-coupling structure and adhesion which are attuned to one another for different surfaces.

In an advantageous embodiment of the domestic appliance, the light-guide body is manufactured with an extrusion method. This means that the technical advantage is achieved for instance that the light-guide body can be produced in large quantities in a cost-effective and precise manner.

In an advantageous embodiment of the domestic appliance, the light source is arranged in a module, which is connected using catch means to a structural element of the door. This means that the technical advantage of a convenient assembly with simple alignment of the lamp is achieved.

In an advantageous embodiment of the domestic appliance, the recessed handle is arranged on an end face of the door. This means that the technical advantage is achieved for instance that a door front side without a recessed handle and an illuminated recessed handle can be provided simultaneously.

With recessed handles on two opposing end faces of the door, both recessed handles can be illuminated. This permits a symmetrical external illumination of the domestic appliance.

In an advantageous embodiment of the domestic appliance, the door has a recessed handle on two opposing end faces and has door hinges close to one of the end faces, and the lamp is arranged on the end face opposing the door hinges or a lamp is arranged on each of the two end faces. This means that the technical advantage is achieved for instance that the side of the door opposing the door hinges can be identified by means of light.

In an advantageous embodiment of the domestic appliance, the light source is a multi-color light source. This means that on the one hand the technical advantage is achieved for instance that the color of the illumination of the recessed handle can be adjusted to the surroundings of the domestic appliance and on the other hand that different operating states of the domestic appliance can be communicated using colors.

In an advantageous embodiment of the domestic appliance, the light source can generate a spatially and/or temporally variable light path. This means that the technical advantage is achieved for instance that different operating states of the domestic appliance can be displayed.

In an advantageous embodiment of the domestic appliance, the domestic appliance has a proximity sensor which can switch on the light source. This means that the technical advantage is achieved for instance that the recessed handle for opening the door is only indicated if a user is in the vicinity of the domestic appliance.

Further advantageous embodiments of the method emerge from the embodiments of the apparatus described above, in order to achieve these. This relates in particular to all apparatuses which can be achieved using films.

Other features which are considered as characteristic for the invention are set forth in the appended claims.

Although the invention is illustrated and described herein as embodied in a domestic appliance with a lamp for illuminating a recessed handle of a door, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a refrigeration appliance according to one embodiment of the invention;

FIG. 2 is a diagrammatic, perspective view of a recessed handle on a door according to one embodiment of the invention;

FIG. 3 is a cross-sectional view of the recessed handle on the door according to a further embodiment of the invention;

FIG. 4 is a schematic, side view of an end face of the door of the refrigeration appliance according to one embodiment of the invention; and

FIG. 5 shows a schematic, perspective view of a lamp when assembled in the recessed handle on the door according to one embodiment of the invention.

### DETAILED DESCRIPTION OF THE INVENTION

In the figures configurations which are independent of one another are realized in the same embodiment for the sake of conciseness. The configurations show, as a domestic appliance, a refrigerator with a storage space for refrigerated goods and a storage space for frozen goods; combinations with further storage spaces, for instance for vegetables, are also covered by the invention.

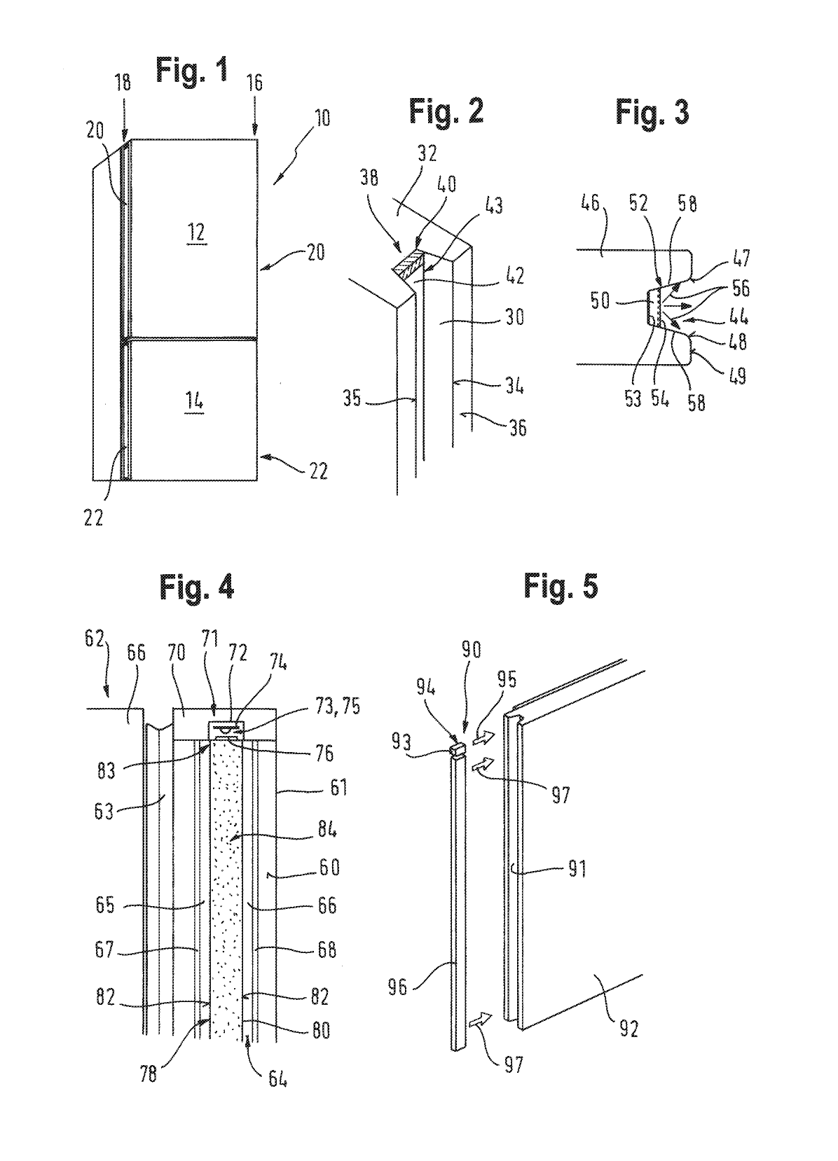

Referring now to the figures of the drawings in detail and first, particularly to FIG. 1 thereof, there is shown a refrigeration appliance 10, representing a domestic appliance, with a refrigerator compartment door 12 to a refrigerator compartment and a freezer compartment door 14 to a freezer compartment. The refrigeration appliance 10 has a hinge side 16 and an opposing door opening side 18. The refrigerator compartment door 12 has a recessed handle 20, which can be illuminated with a lamp, both on the door opening side 18 and also on the hinge side 16. The freezer compartment door 14 has a recessed handle 22, which can be illuminate with a lamp, both on the door opening side 18 and also on the hinge side 16.

Each recessed handle 20, 22 has a light source at both ends, so that the entire recessed handle 20, 22 is illuminated as evenly as possible. On account of the configuration with two recessed handles on each door, the refrigeration appliance 10 has a symmetrical shape as shown, even if the door hinge side is possibly swapped. The light source can optionally be operated such that only the recessed handles on the door opening side 18 are illuminated or that the recessed handles on both door sides 16, 18 are illuminated.

The domestic appliance has a proximity sensor which can switch on the lamp.

FIG. 2 shows a schematic perspective view of a recessed handle 30 on a door 32.

The recessed handle 30 has pronounced edges 34, 35 toward an end face 36 of the door 32.

The refrigeration appliance 10 has a lamp 38 in the door 32 for illuminating the recessed handle 30. The lamp 38 contains a light source assembly 40 and a light-guide body 42. The light source assembly 40 has a light source and serves to hold and provide an electrical connection to the light source, here an LED. The LED illuminates from the light source assembly 40 into the light-guide body 42. The light source assembly 40 and thus the light source is arranged in the door on at least one front end 43 of the light-guide body 42 for illumination into the light-guide body.

FIG. 3 shows a recessed handle 44 on a door 46 in a schematic cross-section, wherein in this illustration the recessed handle 44 has rounded edges 47, 48 toward the end face 49 of the door 46. A light-guide body 50 is inserted into a recess 52 of the recessed handle 44. In this example, the light-guide body 50 is glued into the recess 52 on a rear side 53. The light-guide body 50 has a light out-coupling structure with light out-coupling elements for deflecting light toward a front side 54 of the light-guide body 50. The light out-coupling elements out-couple light in the direction of the arrows 56. One part of the light out-coupled in the direction of the arrows 56 strikes the walls 58 of the recessed handle 44 and thus illuminates the recessed handle 44. The walls 58 of the recessed handle 44 converge in the direction of the interior of the door 46.

FIG. 4 shows an end face 60 of a door 61 of a refrigeration appliance 62, wherein the door 61 has a seal 63, which abuts a housing 66 of the refrigeration appliance 62. The door 61 has a recessed handle 64, the side walls 65, 66 of which form rounded edges 67, 68 with the end face 60 of a door 61. The door 61 also has a cover strip 70.

The door 61 has a lamp 71, which contains a light source assembly 72 and a light-guide body 78. The light source assembly 72 is arranged behind the cover strip 70. The light source assembly 72 supports a light source 73, here an LED 75 on a printed circuit board 74. The LED 75 emits light, which couples via optics 76 into a light-guide body 78. The light-guide body 78 is arranged in a recess 80 of the recessed handle 64, namely glued on side walls of the light-guide body 78 to side walls 82 of the recess 80. The light source assembly 72 and thus the light source 73 is arranged in the door 61 on at least one front end 83 of the light-guide body 78 for illumination into the light-guide body.

The light of the LED 75 coupled into the light-guide body 78 is deflected on unevenly distributed light out-coupling elements 84 on a rear side of the light-guide body 78 and exits from the front of the light-guide body 78 in various lateral directions, with part of it striking the side walls 65, 66 of the recessed handle 64 and thus illuminating the recessed handle 64.

The light source may be a multi-color light source, for instance with a multi-color LED or a number of different-colored LEDs.

The light source may preferably generate a spatially or temporally variable light path. A spatially variable light path can be obtained by actuating a number of LEDs at different times. A temporally variable light path can be realized simply by suitable actuation of one LED.

FIG. 5 shows a schematic perspective view of a lamp 90 being assembled in a recessed handle 91 on a door 92. The lamp 90 contains a light source assembly 94 and a light-guide body 96.

During assembly of the door 92, the light source assembly 94 embodied as a module 93 is introduced into the door 92 in the direction of arrow 95 and when an end position is reached locks with a structural element of the door. Here electrical contacts of the light source assembly 94 make contact with the electrical terminal of the light source.

The light-guide body 96 manufactured using an extrusion method is introduced into the door 92 in the direction of the arrow 97 and adheres to the door when an end position is reached.

The figures clarify various embodiments of a domestic appliance having a door with a recessed handle, wherein the door has a lamp for illuminating the recessed handle, and the recessed handle has a recess, wherein the door has a light-guide body in the recess, and wherein, at least at one front end of the light-guide body, the door also has a light source for illumination into the light-guide body.

All features shown and explained in conjunction with the individual embodiments of the invention can be provided in a different combination in the inventive subject matter in order at the same time to realize their advantageous effects.

The following is a summary list of reference numerals and the corresponding structure used in the above description of the invention:
10 Refrigeration appliance
12 Refrigerator compartment door
14 Freezer compartment door
16 Hinge side
18 Door opening side
20, 22 Recessed handle
30 Recessed handle
32 Door
34, 35 Edges
36 End face
38 Lamp
40 Light source assembly
42 Light-guide body
43 Front end
44 Recessed handle
45 Suction pipe
46 Aluminum film
47, 48 Edges
49 End face
50 Light-guide body
52 Recess
54 Front side
56 Arrows
58 Walls
60 End face
61 Door
63 Seal
64 Recessed handle
65, 66 Side walls
67, 68 Edges
70 Cover strip
71 Lamp
72 Light source assembly
73 Light source
74 Printed circuit board
75 LED
76 Optics
78 Light-guide body
80 Recess
82 Side walls
83 Front end
84 Light out-coupling elements
90 Lamp
91 Recessed handle
92 Door
93 Module
94 Light source assembly
95 Arrow
96 Light-guide body
97 Arrows

1. A domestic appliance, comprising:
a door, containing:
a recessed handle with a recess formed therein;
a lamp for illuminating said recessed handle;
a light-guide body disposed in said recess and having at least one front end; and
a light source disposed at least at said one front end of said light-guide body for illumination into said light-guide body.

2. The domestic appliance according to claim 1, wherein said light source has an LED.

3. The domestic appliance according to claim 1, wherein said lamp has optics for coupling light from said light source into said light-guide body.

4. The domestic appliance according to claim 1, wherein said light-guide body has a surface having a light out-coupling structure with light out-coupling elements for deflecting light.

5. The domestic appliance according to claim 4, wherein said light out-coupling elements are disposed on a front side of said light-guide body which faces an open side of said recessed handle or on an opposing rear side of said light-guide body.

6. The domestic appliance according to claim 4, wherein said light out-coupling elements are unevenly distributed across a length of said light-guide body.

7. The domestic appliance according to claim 1, wherein said light-guide body is glued into said recess of said recessed handle.

8. The domestic appliance according to claim 7, wherein said light-guide body is glued on a rear side or on at least one side surface in said recess of said recessed handle.

9. The domestic appliance according to claim 1, wherein said light-guide body is manufactured using an extrusion method.

10. The domestic appliance according to claim 1,
wherein said door has a structural element; and
further comprising a module connected using catch means to said structural element of said door, said light source is disposed in said module.

11. The domestic appliance according to claim 1, wherein said door has an end face and said recessed handle is disposed on said end face of said door.

12. The domestic appliance according to claim 11, wherein:
said door has two opposing end faces;
said recessed handle is one of two recessed handles, one of said recessed handles disposed in each of said opposing end faces;
said door has door hinges close to one of said end faces; and
said lamp is disposed on one of said end faces opposing said door hinges or said lamp is disposed on each of said two end faces.

13. The domestic appliance according to claim 1, wherein said light source is a multi-color light source.

14. The domestic appliance according to claim 1, wherein said light source can generate a spatially and/or temporally variable light path.

15. The domestic appliance according to claim 1, further comprising a proximity sensor which can switch on said light source.

16. The domestic appliance according to claim 1, wherein the domestic appliance is a domestic refrigeration appliance.
